(19) United States
(12) Patent Application Publication
(10) Pub. No.: US 2007/0007761 A1
(43) Pub. Date: Jan. 11, 2007

(54) Pipe fitting

(76) Inventor: Adrian Nisel, Montreal (CA)

Correspondence Address: Riches, McKenzie & Herbert LLP, Suite 1800, 2 Bloor Street East, Toronto, M4W 3J5, CA

(21) Appl. No.: 11/175,193

(22) Filed: Jul. 7, 2005

(51) Int. Cl. F16L 39/00

(52) U.S. Cl. 285/133.11

(57) ABSTRACT

A fitting for connecting pipes and, in particular, fittings made of plastic and, even more particularly, fittings for connecting PEX or composite pipes, is disclosed. The fitting is used in conjunction with crimp rings which are positioned over the connected pipe either adjacent to, or abutting against, stopper rings on the fitting and adjacent to the end of the pipe.

### FIELD OF THE INVENTION

This invention relates to fittings for connecting pipes and, in particular, fittings made of plastic and, even more particularly, fittings for connecting PEX or composite pipes.

### BACKGROUND OF THE INVENTION

In the past, pipe fittings have been made primarily of brass and crimp rings which secure the pipe to the connector portions of the fittings have been spaced apart and away from the ends of the pipes. For example, refer to U.S. Pat. No. 6,095,571 to MacDuff and U.S. Pat. No. 6,523,862 also to MacDuff. Also, prior art fittings are disclosed in U.S. Pat. No. 4,648,628 to Meadows.

More specifically, in the past, traditional PEX and composite pipe fittings required a crimp ring, usually a copper crimp ring, to be positioned about ⅛th inch to ¼ inch from the end of the pipe for the best seal.

With the prior art fittings, it was difficult to test whether or not the crimp ring had been properly installed.

### SUMMARY OF THE INVENTION

Accordingly, it is an object of this invention to at least partially overcome the disadvantages of the prior art and also to provide an alternative fitting, particularly useful for PEX and composite pipe. It is an object of this invention to provide an improved type of fitting for pipes and, particularly for PEX and composite pipes, and particularly to provide a plastic fitting with improved features.

Accordingly, in one of its aspects, this invention resides in providing a fitting comprising: a first connector portion for insertion into a first pipe having a pre-determined inner diameter and to be secured within the first pipe by a first crimp ring; a second connector portion for insertion into a second pipe having a pre-determined inner diameter and to be secured within the second pipe by a second crimp ring; the first connector portion having a first longitudinal, cylindrical portion for insertion into the first pipe, and wherein the first cylindrical portion has a lead end for insertion into the first pipe and a trailing end opposite to the lead end; two first spaced-apart concentric rings on a radially-outer portion of the first cylindrical portion wherein a maximum outer radial distance of the first concentric rings is no greater than the inside diameter of the first pipe; a first stopper ring positioned at the trailing end of the first cylindrical portion of the first connector portion and at a pre-determined longitudinal distance from the first concentric rings, and wherein the pre-determined longitudinal distance is determined such that when the first crimp ring is crimped in place the first concentric rings will be positioned in a functionally-acceptable position relative to the first crimp ring; and the second connector portion having a second longitudinal, cylindrical portion for insertion into the second pipe, and wherein the second cylindrical portion has a lead end for insertion into the second pipe and a trailing end opposite to the lead end; two second spaced-apart concentric rings on a radially-outer portion of the first cylindrical portion wherein a maximum outer radial distance of the second concentric rings is no greater than the inside diameter of the second pipe; and; a second stopper ring positioned at the trailing end of the second cylindrical portion of the second connector portion and at a pre-determined longitudinal distance from the second concentric rings, and wherein the pre-determined longitudinal distance is determined such that when the second crimp ring is crimped in place the second concentric rings will be positioned in a functionally-acceptable position relative to the second crimp ring.

In another aspect, the present invention resides in providing the above-described fitting together with a first gasket positioned between the first two concentric rings and a second gasket positioned between the second two concentric rings.

In a further aspect, the present invention resides in providing the above-described fittings made of plastic.

In another aspect, the present invention resides in providing a method of connecting a first pipe having a pre-determined inner diameter to a second pipe having a pre-determined inner diameter, wherein the method includes providing a fitting as described above; inserting the first cylindrical portion of the first connector portion of the fitting into the first pipe; inserting the second cylindrical portion of the second connector portion into the second pipe; positioning and crimping a first crimp ring around the first pipe adjacent, and preferably butting against, the first stopper ring of the first connector portion to secure the first pipe to the first connector portion of the fitting; and positioning and crimping a second crimp ring around the second pipe adjacent to, and preferably butting against, the second stopper ring of the second connector portion of the fitting to secure the second pipe to the second connector portion of the fitting

Further aspects of the invention will become apparent upon reading the following detailed description and drawings which illustrate the invention and preferred embodiments of the invention.

### BRIEF DESCRIPTION OF THE DRAWINGS

In the drawings, which illustrate embodiments of the invention:

FIG. 1 is a top view of an installed preferred embodiment of the invention;

FIG. 2 is a top view of an uninstalled preferred embodiment of the invention;

FIG. 3 is a top view, and partial cross-section, of an installed preferred embodiment of the invention;

FIG. 4 is a perspective view of an uninstalled preferred embodiment of the invention;

FIG. 5 is a schematic cross-sectional view along line 5-5 in FIG. 2;

FIG. 6 is an end view of a crimp ring; and

FIG. 7 is a perspective view of another embodiment of the invention.

### DETAILED DESCRIPTION OF THE PREFERRED EMBODIMENTS

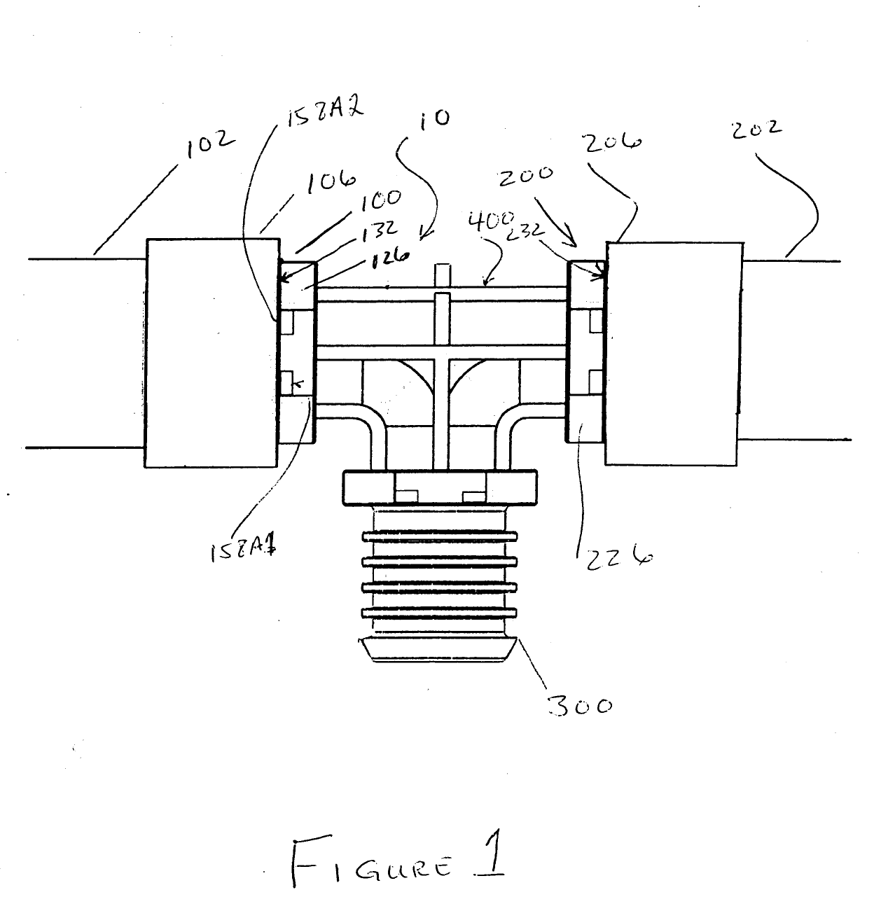

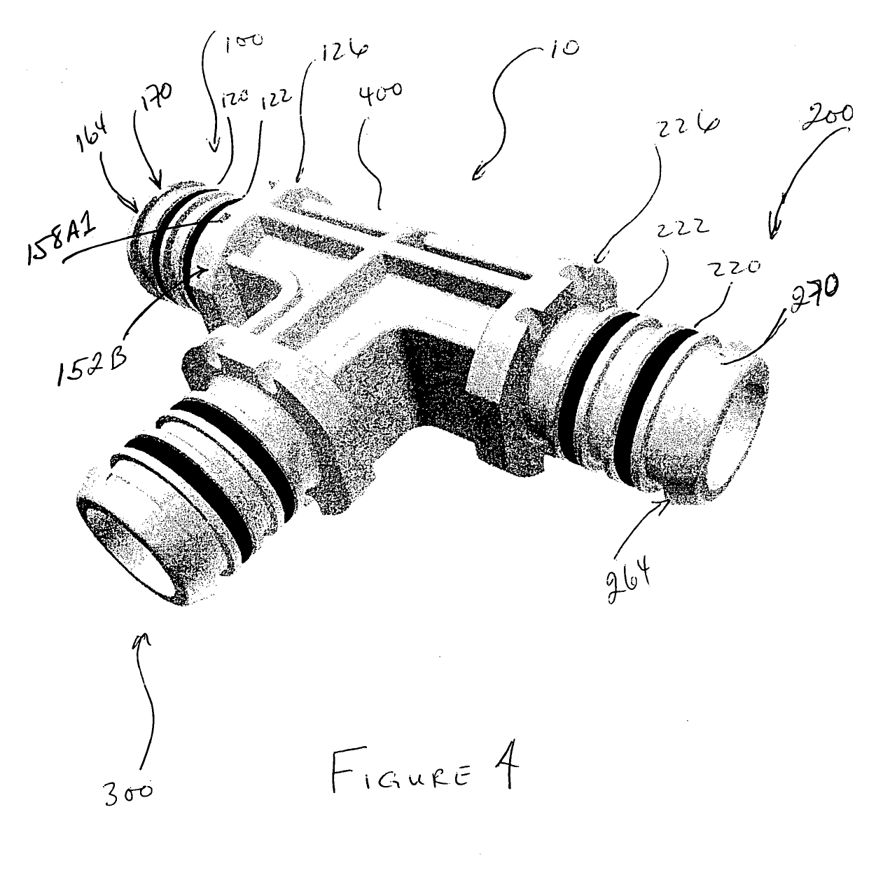

As shown in FIGS. 1, 2, 3 and 4, one embodiment of the present invention relates to a fitting 10 comprising a first connector portion 100 for insertion into a first pipe 102 having a pre-determined inner diameter 104 and to be secured within the first pipe 102 by a first crimp ring 106.

There is also a second connector portion 200 for insertion into a second pipe 202 having a pre-determined inner diameter 204 and to be secured within the second pipe 202 by a second crimp ring 206.

In some fittings, such as elbows, there may be only two connector portions, namely the first connector portion and a second connector portion. However, in other fittings, such as T's, there may be a third connector portion 300 for insertion into a third pipe (not shown) having a pre-determined inner diameter and to be secured within the third pipe by a third crimp ring (not shown). The characteristics of the third connector portion are substantially the same as the characteristics of the first and second connector portions as described herein.

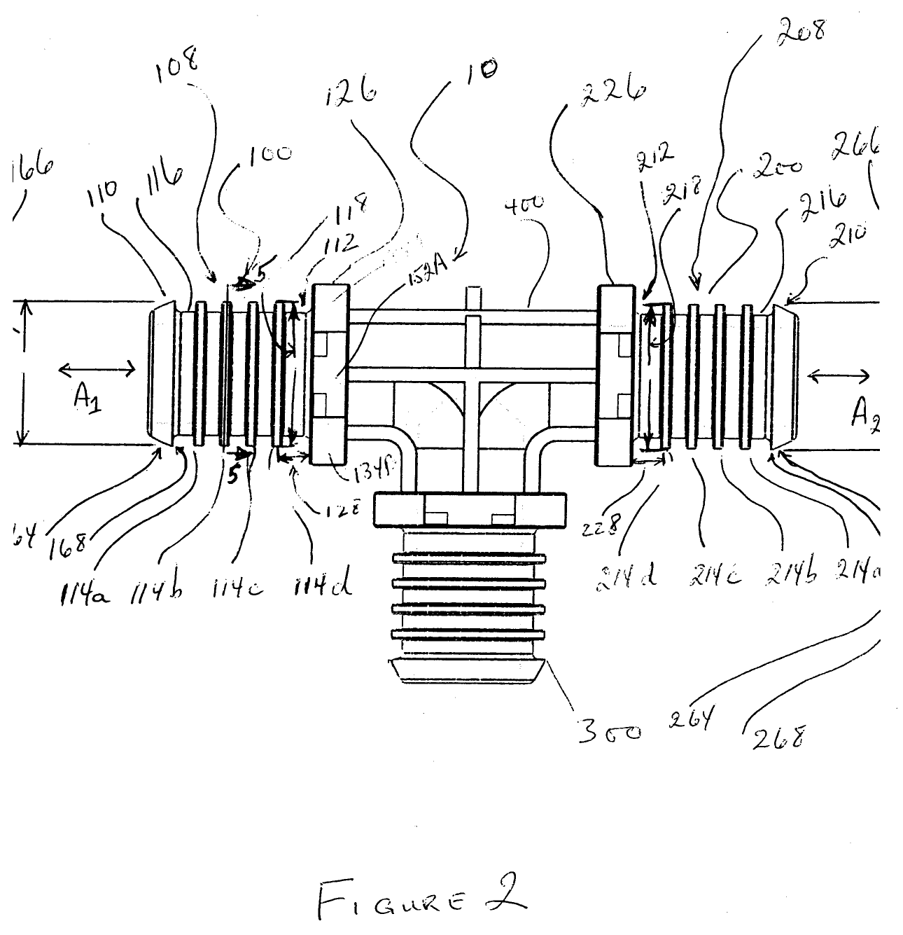

The first connector portion 100 has a first longitudinal, cylindrical portion 108 (as best seen in FIG. 2) for insertion into the first pipe 102. The first cylindrical portion 108 has a lead end 110 for insertion into the first pipe 102 and a trailing end 112 opposite to the lead end 110.

Preferably the second connector portion 200 is substantially the same as the first connector portion 100. In particular, preferably the second connector portion 200 has a second longitudinal, cylindrical portion 208 for insertion into the second pipe 202. Also, the second cylindrical portion 208 has a lead end 210 for insertion into the second pipe 202 and a trailing end 212 opposite to the lead end 210.

The first connector portion 100 has at least two first spaced-apart concentric rings 114a and 114b on a radially-outer portion 116 of the first cylindrical portion 100. Preferably in a fitting designed for PEX pipe, there are only two first spaced-apart concentric rings 114a and 114b. However, in a fitting designed for composite pipe, preferably there are two sets of first spaced-apart concentric rings as shown in FIG. 2 as elements 114a, 114b, 114c and 114d.

The maximum outer radial distance 118 of the first concentric rings 114 is no greater than the inside diameter 104 of the first pipe 102.

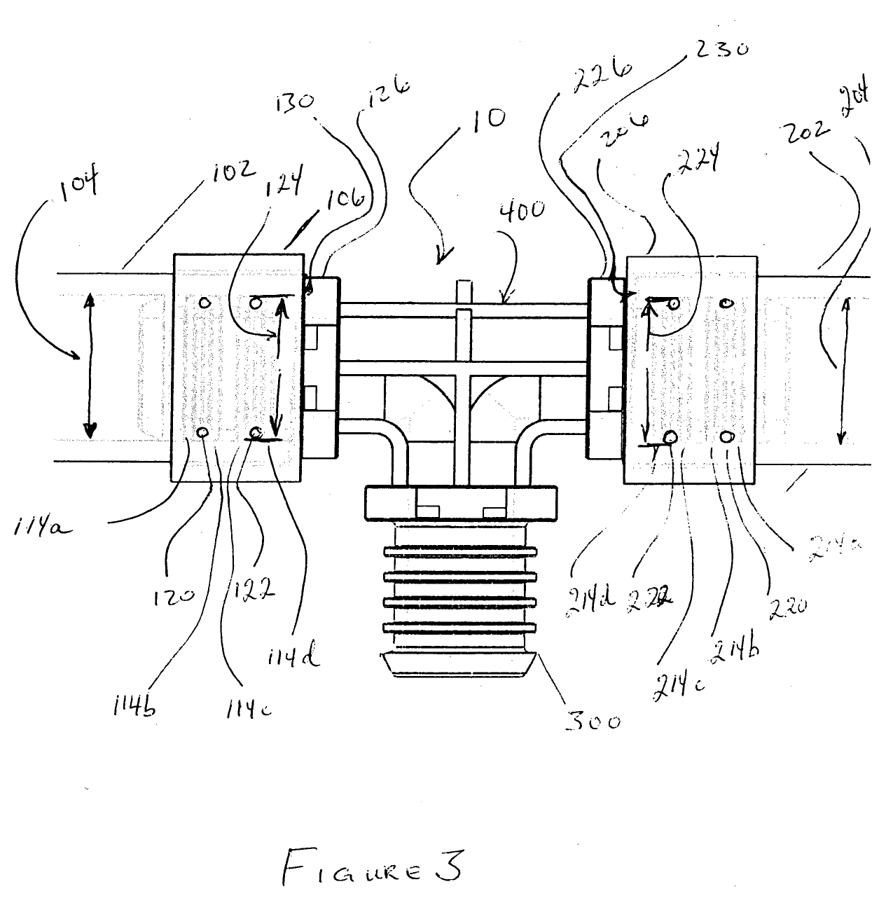

In a preferred embodiment which is particularly useful for composite pipes, particularly composite pipes consisting of an aluminium tube laminated between two layers of polyethylene, a first gasket 120 (FIG. 3) is positioned between two concentric rings 114a and 114b on the first connector portion 100. On the second connector portion 200 a second gasket 220 is positioned between two concentric rings 214a and 214b. Preferably, there is a second set of concentric rings 114c and 114d on the first connector portion 100 and a second set of concentric rings 214c and 214d on the second connector portion 200. In this embodiment, it is preferred to have another gasket 122 positioned between the second set of concentric rings 114c and 114d. Similarly, it is preferred to have another gasket 222 positioned between the second set of concentric rings 214c and 214d on the second connector portion 200.

Preferably, the gaskets 120, 122, 220 and 222 are O-rings.

In a further preferred embodiment, each of the first gasket 120 and the other gasket 122 is seated to have a maximum outer radial distance 124 no greater than the maximum outer radial distance 118 of the first concentric rings 114. Similarly, each of the second gasket 220 and the other gasket 222 is seated to have a maximum outer radial distance 224 no greater than the maximum outer radial distance 218 of the second concentric rings 214 of the second connector portion 200 (the reason why this embodiment is preferred is discussed below).

Referring again to FIG. 2, the fitting 10 includes a first stopper ring 126 positioned at the trailing end 112 of the first cylindrical portion 108 of the first connector portion 100. The first stopper ring 126 is positioned a pre-determined longitudinal distance 128 from the first concentric rings 114. The pre-determined longitudinal distance 128 is determined such that when the first crimp ring 106 is crimped in place the first concentric rings 114 will be positioned in a functionally-acceptable position relative to the first crimp ring 106. A functionally-acceptable position is one that results in a functionally-acceptable seal, either where there are no gaskets when PEX pipe is being connected or when first gasket 120 and other gasket 122 are used in a preferred embodiment particularly adapted for composite pipe.

Similarly, there is a second stopper ring 226 positioned at the trailing end 212 of the second cylindrical portion 208 of the second connector portion 200. The second stopper ring 226 is positioned a pre-determined longitudinal distance 228 from the second concentric rings 214. The pre-determined longitudinal distance 228 is determined such that when the second crimp ring 206 is crimped in place the second concentric rings 214 will be positioned in a functionally acceptable position relative to the second crimp ring 206. A functionally-acceptable position is one that results in a functionally-acceptable seal, either where there are no gaskets when PEX pipe is being connected or when second gasket 220 and other gasket 222 are used in a preferred embodiment particularly adapted for composite pipe.

Positioned between the first stopper ring 126 and the second stopper ring 226 may be, and in some embodiments should be, a body portion 400. Preferably the body portion 400 is suitably ribbed to provide sufficient rigidity, but also sufficient flexibility. A suitably-ribbed body portion 400 permits the fitting 10 to bend and absorb the strain imparted by pipe installation, particularly by composite pipe installation.

T-shaped and elbow-shaped fittings may be designed to act as “springs” to a certain extent, thereby absorbing much of the bending momentum which would otherwise have gone to weaken points in the fitting 10.

However, in some embodiments, such as compact connectors, there is no body portion, for example as seen in FIG. 7. In this embodiment, the fitting 10′ has a first connector portion 100′ and a second connector portion 200′ which are substantially the same as the first connector portion 100 and the second connector portion 200 as previously described, except that the first stopper ring 126′ and the second stopper ring 226′ are the same physical piece.

In the past, crimp rings have always been positioned such that there is space between the end of the pipe and the edge of the crimp ring. Typically there would be a gap of about ⅛ inch to ¼ inch between the end of the pipe and the forward edge of the crimp ring.

Surprisingly, the inventor has discovered that significant advantages can be obtained when the forward edge of the crimp ring is adjacent to the end of the pipe. In particular, it has been discovered that if the first pipe 102 is positioned such that the forward end 130 of the first pipe 102 is positioned adjacent to, and preferably abutting against, the first stopper ring 126 of the first connector portion 100, and the forward edge 132 of the first crimp ring 106 is also adjacent to, and preferably abutting against, the first stopper ring 126, the fitting 10 is better protected against bending forces during installation and, therefore, the size of the fitting 10 and the cost of the fitting 10 can be reduced.

A similar situation applies with respect to the second pipe 202, the second crimp ring 226 and the second stopper ring 226.

Also, when the crimp rings 106 and 206 are adjacent to the ends 130 and 230 of the pipes 102 and 202, it is much easier to obtain a consistently satisfactory fluid seal because the gaskets 120, 122, 220 and 222 and/or the concentric rings 114 and 214 can be positioned so that the crimp rings 106 and 206 are compressed equally around the gaskets 120, 122, 220 and 222 and/or the concentric rings 114 and 214.

Preferably, the fitting 10 is made from plastic, and preferably from a polyphenylsulfone resin or blend such as RADEL R (trade mark) polyphenylsulfone resin or ACUDEL (trade mark) polyphenylsulfone blend.

Preferably, the fittings 10 made from plastic will have the same inner diameter as ASTM F-1974 brass fittings.

The fittings 10 may also be made from other suitable materials, such as metal alloys including brass or stainless steel, and in which case at least some of the advantages of this invention will still be obtained.

In use, a plumber or other user is provided with fittings 10 to connect the first pipe 106 having a pre-determined inner diameter 104 to a second pipe 202 having a pre-determined inner diameter 204. The fitting 10 is selected such that the sizing of the fitting 10 corresponds to the inner diameters 104 and 204 of the first and second pipes 102 and 202.

The plumber or user inserts the first cylindrical portion 108 of the first connector portion 100 of the fitting 10 into the first pipe 102 such that the forward end 130 of the first pipe 102 is positioned adjacent to, and preferably abutting against, the first stopper ring 126 of the first connector portion 100. Preferably the crimp ring 106 is placed loosely around the first pipe 102 before the first cylindrical portion 108 is inserted into the first pipe 102.

Similarly, preferably the crimp ring 206 is placed loosely around the second pipe 202 and then the second cylindrical portion 208 of the second connector portion 200 is inserted into the second pipe 202 such that the forward end 230 of the second pipe 202 is positioned adjacent to, and preferably abutting against, the second stopper ring 226 of the second connector portion 200.

The first crimp ring 106 is moved into position around the first pipe 106 adjacent to the first stopper ring 126, and preferably with the forward edge 132 of the crimp ring 106 abutting against the first stopper ring 126. Similarly, the second crimp ring 206 is moved into position around the second pipe 202 adjacent to the second stopper ring 226, and preferably with the forward edge 232 of the crimping ring abutting against the second stopper ring 226.

The first crimp ring 106 is then crimped to secure the first pipe 102 to the first connector portion 100 of the fitting 10. Similarly, the second crimp ring 206 is crimped to secure the second pipe 202 to the second connector portion 200 of the fitting 10.

A sought-after benefit of positioning the crimp rings 106 and 206 abutting against the first and second stopper rings 126 and 226 is that the crimp rings are always crimped in the same position relative to the gaskets and/or concentric rings. This provides a consistent water seal from one connection to the next.

In the past, when the crimp ring was positioned ⅛ inch to ¼ inch from the end of the pipe, the crimp ring could end up in various positions relative to the gaskets and concentric rings. For example, sometimes only one of the two gaskets would be compressed and usually the two gaskets were not compressed equally.

In a preferred embodiment, the concentric rings 114 and 214, as well as the gaskets 120, 122, 220 and 222, are positioned such that when the forward ends 130 and 230 of the pipes 102 and 202 and the forward edges 132 and 232 of the crimp rings 106 and 206 are positioned abutting against the first and second stopper rings 126 and 226, the gaskets 120, 122, 220 and 222, as well as the concentric rings 114 and 214, will be equally or symmetrically spaced in relation to the position of the crimp rings 106 and 206, thus providing equal compression at the respective gaskets and concentric ring associated with the respective crimp ring and, therefore, a preferred water seal.

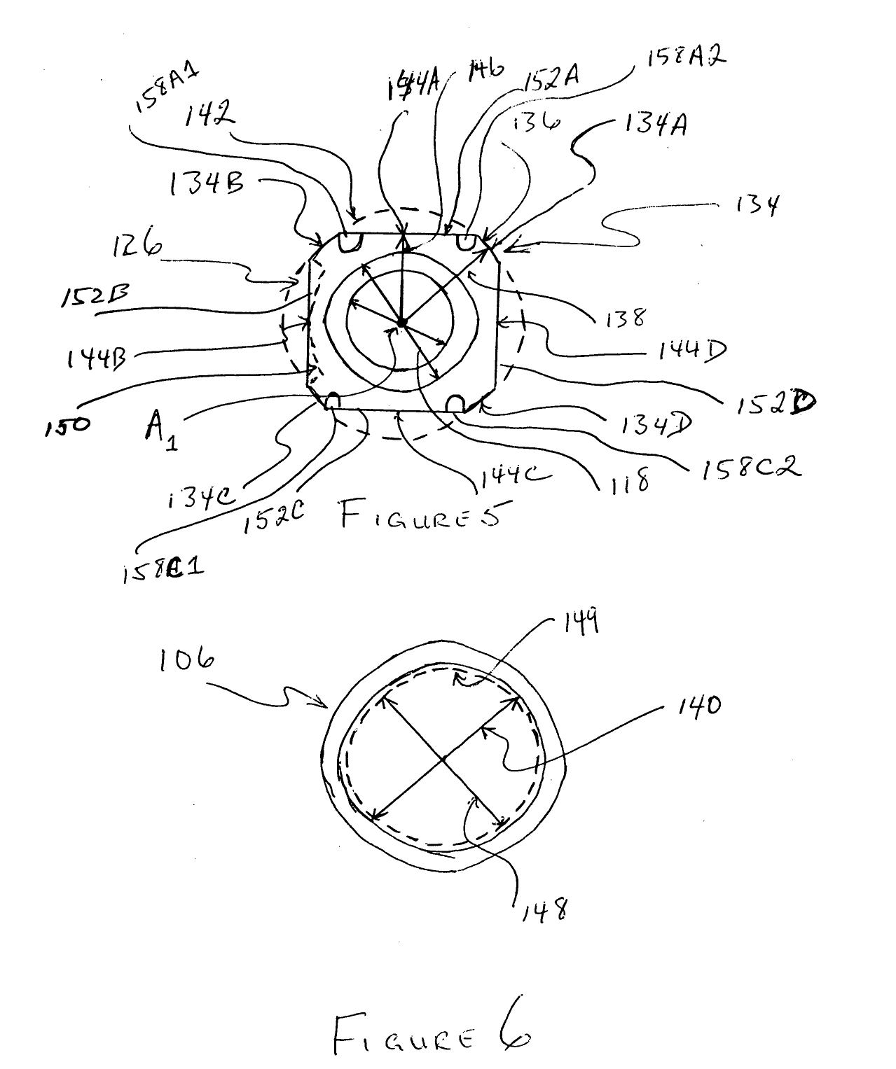

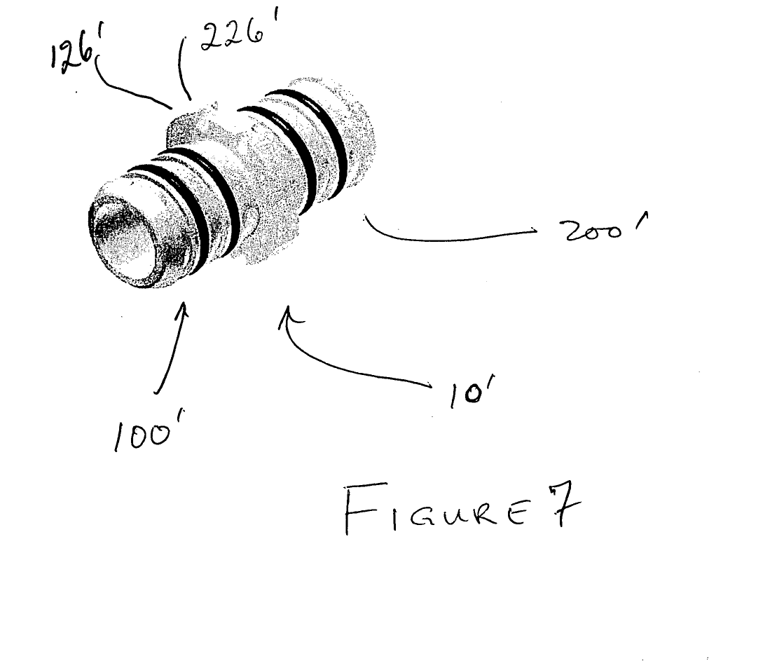

In a further preferred embodiment of the fitting 10, as best seen in FIG. 5, the first stopper ring 126 of the first connector portion 100 has an outer periphery 134. At least one first portion 136 of the outer periphery 134 has a first predetermined radial distance 138 from the longitudinal axis A₁ of the first connector portion 100 which is greater than one half the inner diameter 140 (seen in FIG. 6) of the first crimp ring 106 before the first crimp ring 106 is crimped.

In this manner, the first crimp ring 106 is prevented from moving longitudinally beyond the first stopper ring 126.

Similarly, the second stopper ring 226 of the second connector portion 200 has a structural arrangement similar to that of connector portion 100 such that the second crimp ring 206 is prevented by the second stopper ring 226 from moving longitudinally beyond the second stopper ring 226.

In a further preferred embodiment of the invention, the at least one first portion 136 of the outer periphery 134 of the first stopper ring 126 coincides with the outer periphery 134. In this embodiment, it is preferred that the outer periphery 134 be circular as shown by dashed lines 142 in FIG. 5 and that the diameter of the circular periphery 142 be greater than the inner diameter 140 of the first crimp ring 106 before the first crimp ring 106 is crimped.

Similarly, the second stopper ring 226 of the second connector portion 200 has a similar structural arrangement.

In a further preferred embodiment, the first portion 136 of the outer periphery 134 is comprised of four peripheral segments 134A, 134B, 134C and 134D, wherein these peripheral segments are arcs of the circular periphery 142.

In a further preferred embodiment, the first stopper ring 126 of the first connector portion 100 has at least one second portion 144 of its outer periphery 134 at a second pre-determined radial distance 146. The second pre-determined radial distance 146 corresponds to the upper limit of the maximum inner diameter 148 of a properly-crimped first crimp ring 106 (as shown by dashed lines 149 in FIG. 6).

There are ASTM standards setting the upper limit of the maximum inner diameter of a properly-crimped crimp ring. If the crimp ring is not crimped sufficiently such that the inner diameter of the crimped crimp ring is greater than the upper limit of the maximum inner diameter of a properly-crimped crimp ring, the crimp ring is under-crimped and creates a risk of early joint failure.

Thus, in the preferred embodiment being described, if the inner diameter of a crimped crimp ring 106 is ever greater than the second pre-determined radial distance 146 at the at least one second portion 144 of the outer periphery 134 that is a signal or indication to the worker that the crimp ring 106 is under-crimped.

Similarly, in this preferred embodiment, the second stopper ring 226 of the second connector portion 200 has a similar structural arrangement such that when the second crimp ring 206 is under-crimped the worker will be able to visually observe the under-crimping.

In the embodiment shown in FIG. 5, there are four second portions 144A, 144B, 144C and 144D of the outer periphery 134 of the first stopper ring 126.

In one embodiment, the second portion 144 has a circular periphery or arcs of a circular periphery as shown as dashed lines 150 in FIG. 5.

However, for ease of molding and construction, in a preferred embodiment, the second portions 144 are included in four flat peripheral portions 152A, 152B, 152C and 152D.

Although four flat peripheral portions 152 are shown in FIG. 5, there could be only one, two or three such flat peripheral portions.

Each of the flat peripheral portions 152A, 152B, 152C and 152D has a point 144A, 144B, 144C and 144D that corresponds to the upper limit of the maximum inner diameter 148 of a properly-crimped first crimp ring 106.

The four flat peripheral portions 152A, 152B, 152C and 152D are basic linear measuring levels. Because plastic pipe varies too much dimensionally to ever be crimped perfectly round or even perfectly concentric with the fitting, a circular measuring device such as the circular periphery 150 on the first stopper ring 126 is not always ideal.

Because only a few thousandths of an inch may make a difference between a good and a bad crimp, the immediate visibility of an improperly-crimped crimp ring will alert the worker to a potential problem.

If the pipes 102 and 202 have a colour, such as red, orange or blue, which is contrasting with or at least different than the colour of the fitting 10, preferably white, the under-crimping is more easily and quickly observed without using additional time-consuming, cumbersome or expensive gauging tools for that purpose.

If the outer periphery 134 of the first stopper ring 126 were greater than one half of the outside diameter of the crimped first crimp ring 106 when crimped there is a risk that if the worker did not accurately place the crimping tool (not shown) only around the crimp ring 106, but also placed the crimping tool around the first stopper ring 126, the first stopper ring 126 could be crushed when the crimping tool crimps the first crimp ring 106.

Therefore, in a preferred embodiment, the first stopper ring 126 has a predetermined maximum outer peripheral radial distance from the longitudinal axis A₁ of the first connector portion 100 which is less than one half of the of the minimum outer diameter of the first crimp ring 106 when crimped.

Similarly, the second stopper ring 226 of the second connector portion 200 has a similar structural arrangement so as to prevent crushing of the second stopper ring 226 by the crimping tool.

In a further preferred embodiment of the fitting 10, the first stopper ring 126 of the first connector portion 100 has at least one third portion 158 of its outer periphery 134 at a third pre-determined radial distance 160 from the longitudinal axis A₁ of the first connector portion 100 that is less than one half the inner diameter 162 of a properly-crimped first crimp ring 106.

Preferably at least one third portion 158 of the outer periphery 134 of the first stopper ring 126 on the first connector portion 100 is a slot for example 158A1, 158A2, 158C1 or 158C2,in the at least one flat peripheral portion 152A or 152C.

Thus, both before the crimp ring 106 is fully positioned and even after the crimp ring 106 is crimped into position, a worker can look through the slots 158A and 158C to see whether or not the end 130 of the pipe 102 is abutting against, or at least adjacent to, the first stopper ring 126.

Similarly, the second stopper ring 226 of the second connector portion 200 has a similar structural arrangement so as to allow the worker to view the end 230 of the second pipe 202 to ensure that the second pipe 202 abuts against, or is at least adjacent to, the second stopper ring 226.

In a further preferred embodiment, the first cylindrical portion 108 of the first connector 100 has a first gripper ring 164 on the radially-outer portion 116 and at the lead end 110 of the first connector portion 100.

Similarly, the second cylindrical portion 208 of the second connector 200 has a second gripper ring 264 on the radially outer portion 216 and at the lead end 210 of the second connector portion 200.

Preferably, the first gripper ring 164 of the first connector portion 100 has a pre-determined maximum radial distance 166 which is marginally greater than the inner diameter 104 of the first pipe 102. Similarly, the second gripper ring 264 of the second connector portion 200 has a pre-determined maximum radial distance 266 which is marginally greater than the inner diameter 204 of the second pipe 202.

Even more preferably, the first gripper ring 164 on the first connector portion 100 has a first pipe-gripping edge 168 facing towards the trailing end 112 of the first cylindrical portion 100. Similarly, the second gripper ring 264 of the second connector portion 200 has a second pipe-gripping edge 268 facing towards the trailing end 212 of the second cylindrical portion 200.

The purpose of the first gripper ring 164 and second gripper ring 264 is to prevent the fitting 10 from coming out of the respective pipes 102 and 202 during installation and before crimping. This feature is particularly useful when the fitting 10 hangs vertically from one of the pipes 102 or 202. Because the installer needs both hands to operate the crimping tool, it is difficult for the installer to also hold the fitting 10 in place without the first gripping ring 164 and the second gripper ring 264.

Unfortunately, there is a long standing problem in the plumbing industry with accidentally missing connections on the job site. Because of the high number of similar-looking joints which a plumber must install quickly during any given day, it naturally happens that, despite the fitting being inserted into the pipe, the plumber inadvertently misses crimping one of the pre-positioned crimp rings on that connection.

Usually a system pressure test is performed when the job is completed to detect these types of over-looked or forgotten crimps. During these tests, the first gripper ring 164 and the second gripper ring 264 can act as effective, but misleading, seals. This is especially so if the first and second pipe-gripping edges 168 or 268 grip into the pipes 102 and 202 when the fitting 10 is fully inserted.

To eliminate this situation, a portion 170 of the first gripper ring 164 is provided which has a pre-determined radial distance 172 from the axis Al of the first connector portion 100 that is less than the one half of the inner diameter 104 of the first pipe 102.

Similarly, the second gripper ring 264 of the second connector portion 200 has a second portion 270 having a pre-determined radial distance 172 from the axis A₂ of the second connector portion 200 that is less than one half of the inner diameter 204 of the second pipe 202.

The second portions 170 and 270 ensure a water path by which water can escape from the fitting 10 during a system pressure test if the crimp rings 106 or 206 are not crimped.

The second portions 170 and 270 are completely filled with pipe material when the crimping operation is actually performed.

Preferably the second portions 170 and 270 are slots molded into the fitting 10 at the time of manufacture.

Preferably there are two such slots that are diametrically opposed around the first gripper ring 264 and two diametrically opposed slots around the second gripper ring 264.

Also, in order to assist in ensuring that uncrimped crimp rings do not go undetected during a system pressure test, in a further preferred embodiment, as noted above, each of the first gasket 120 and the other gasket 122 is seated to have a maximum outer radial distance 124 no greater than the maximum outer radial distance 118 of the first concentric rings 114. Similarly, each of the second gasket 220 and the other gasket 222 is seated to have a maximum outer radial distance 224 no greater than the maximum outer radial distance 218 of the second concentric rings 214 of the second connector portion 200.

If any of the gaskets 120, 122, 220 and 222 has a maximum outer radial distance 124 greater than the maximum outer radial distance 118 or 218 of the concentric rings 114 or 214, such gasket would form an effective, but misleading, seal during the system pressure test thereby allowing the plumber to over-look an uncrimped crimp ring. Therefore, in order to avoid this situation, the maximum outer radial distances 124 and 224 of the various gaskets 120, 122, 220 and 222 are designed and made to have maximum outer radial distances 124 and 224 no greater than the maximum outer radial distances 118 and 218 of the first concentric rings 114 and the second concentric rings 224, respectively.

In use, a plumber, or other suitable worker, uses the fitting 10 to connect the first pipe 102 having a pre-determined inner diameter 104 to a second pipe 202 having a pre-determined inner diameter 204. Firstly, a fitting 10 as described herein is provided to or obtained by the plumber. The plumber inserts the first cylindrical portion 108 of the first connector portion 100 of the fitting 10 into the first pipe 102 such that the forward end 130 of the first pipe 102 is adjacent to, and preferably abutting against, the first stopper ring 126.

The plumber then inserts the second cylindrical portion 208 of the second connector portion 200 into the second pipe 202 such that the forward end 230 of the second pipe is adjacent to, and preferably abutting against, the second stopper ring 226.

The plumber then positions the first crimp ring 106 around the first pipe 102 adjacent to, and preferably abutting against, the first stopper ring 126 of the first connector portion 100. The plumber similarly positions the second crimp ring 206 around the second pipe 202 adjacent to, and preferably abutting against, the second stopper ring 226 of the second connector portion 200.

The plumber then crimps the first crimp ring 106 around the first pipe 102 to secure the first pipe 102 to the first connector portion 100 of the fitting 10. Similarly, the plumber crimps the second crimp ring 206 around the second pipe 202 to secure the second pipe 202 to the second connector portion 200 of the fitting 10.

If the fitting 10 is a “T” and has a third connector portion 300, the plumber engages in similar steps to position and crimp a third crimp ring (not shown) around the third pipe.

In another aspect, this invention resides in providing a pipe assembly comprising the fittings as described herein wherein the first connector portion 100 is inserted into the first pipe 102 and secured within the first pipe 102 by a first crimp ring 106 (as shown in FIG. 1), and wherein the second connector portion 200 is inserted into the second pipe 202 and secured within the second pipe 202 by a second crimp ring 206.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments which are functional or mechanical equivalents of the specific embodiments and features that have been described and illustrated herein.

1. A fitting comprising:
a first connector portion for insertion into a first pipe having a pre-determined inner diameter and to be secured within the first pipe by a first crimp ring;
a second connector portion for insertion into a second pipe having a pre-determined inner diameter and to be secured within the second pipe by a second crimp ring;
the first connector portion having a first longitudinal, cylindrical portion for insertion into the first pipe, and wherein the first cylindrical portion has a lead end for insertion into the first pipe and a trailing end opposite to the lead end;
two first spaced-apart concentric rings on a radially-outer portion of the first cylindrical portion wherein a maximum outer radial distance of the first concentric rings is no greater than the inside diameter of the first pipe;
a first stopper ring positioned at the trailing end of the first cylindrical portion of the first connector portion and at a pre-determined longitudinal distance from the first concentric rings, and wherein the pre-determined longitudinal distance is determined such that when the first crimp ring is crimped in place the first concentric rings will be positioned in a functionally-acceptable position relative to the first crimp ring; and
the second connector portion having a second longitudinal, cylindrical portion for insertion into the second pipe, and wherein the second cylindrical portion has a lead end for insertion into the second pipe and a trailing end opposite to the lead end;
two second spaced-apart concentric rings on a radially-outer portion of the first cylindrical portion wherein a maximum outer radial distance of the second concentric rings is no greater than the inside diameter of the second pipe; and;
a second stopper ring positioned at the trailing end of the second cylindrical portion of the second connector portion and at a pre-determined longitudinal distance from the second concentric rings, and wherein the pre-determined longitudinal distance is determined such that when the second crimp ring is crimped in place the second concentric rings will be positioned in a functionally-acceptable position relative to the second crimp ring.

2. A fitting as defined in claim 1 wherein the first crimp ring has an inner diameter;
the first stopper ring of the first connector portion has an outer periphery and at least one first portion of the outer periphery has a first predetermined radial distance from the longitudinal axis of the first connector portion which is greater than one half the inner diameter of the first crimp ring before it is crimped;
the second crimp ring has an inner diameter, and
the second stopper ring of the second connector portion has an outer periphery and at least one first portion of the outer periphery has a first predetermined radial distance from the longitudinal axis of the second connector portion which is greater than one-half the inner diameter of the second crimping ring before it is crimped.

3. A fitting as defined in claim 2 wherein the first predetermined radial distance of the at least one first portion of the outer periphery of the first stopper ring of the first connector portion is a circular periphery having an outer diameter greater than the inner diameter of the first crimp ring; and
the second predetermined radial distance of the at least one first portion of the outer periphery of the second stopper ring of the second connector portion is a circular periphery having an outer diameter greater than the inner diameter of the second crimp ring.

4. A fitting as defined in claim 2 wherein there is an upper limit of the maximum inner diameter of a properly-crimped first crimp ring;
the first stopper ring of the first connector portion has at least one second portion of its outer periphery at a second pre-determined radial distance that corresponds to the upper limit of the maximum inner diameter of a properly-crimped first crimp ring;
there is an upper limit of the maximum inner diameter of a properly-crimped second crimp ring; and
the second stopper ring of the second connector portion has at least one second portion of its outer periphery at a second pre-determined radial distance that corresponds to the upper limit of the maximum inner diameter of a properly-crimped second crimp ring.

5. A fitting as defined in claim 2wherein the first stopper ring has at least one flat peripheral portion and each flat peripheral portion has a print that corresponds to the upper limit of the maximum inner diameter of a properly-crimped first crimp ring;
the second stopper ring has at least one flat peripheral portion and each flat peripheral portion has a point that corresponds to the upper limit of the maximum inner diameter of a properly-crimped second crimp ring;
there are two or more second portions of the second stopper ring of the second connector portion and each of those second portions is flat.

6. A fitting as defined in claim 5 wherein the first stopper ring of the first connector portion has at least one third portion of its outer periphery at a third pre-determined radial distance that is less than the inner diameter of a properly-crimped first crimp ring; and
the second stopper ring of the second connector portion has at least one third portion of its outer periphery at a third pre-determined radial distance that is less than the inner diameter of a properly-crimped second crimp ring.

7. A fitting as defined in claim 6 wherein the at least one third portion of the outer periphery of the first stopper ring on the first connector portion is a slot in the at least flat peripheral portion of the outer periphery of the first stopper ring of the first connector portion; and
the at least one third portion of the outer periphery of the second stopper ring on the second connector portion is a slot in the at least flat peripheral portion of the outer periphery of the second stopper ring of the second connector portion.

8. A fitting as defined in claim 7 wherein there are two slots in the at least one flat peripheral portion of the outer periphery of the first stopper ring of the first connector portion; and
there are two slots in the at least one flat peripheral portion of the outer periphery of the second stopper ring of the second connector portion.

9. A fitting as defined in each of the preceding claims wherein the first cylindrical portion of the first connector has a first gripper ring on the radially-outer portion and at the lead end of the first connector portion; and
the second cylindrical portion of the second connector has a second gripper ring on the radially-outer portion and at the lead end of the second connector portion.

10. A fitting as defined in claim 9 wherein the first gripper ring of the first connector portion has a maximum radial distance which is marginally greater than the inner diameter of the first pipe; and
the second gripper ring of the second connector portion has a maximum radial distance which is marginally greater than the inner diameter of the second pipe.

11. A fitting as defined in claim 9 wherein the first gripper ring on the first connector portion has a first pipe-gripping edge facing towards the trailing end of the first cylindrical portion; and
the second gripper ring on the second connector portion has a second pipe-gripping edge facing towards the trailing end of the second cylindrical portion.

12. A fitting as defined in claim 9wherein the first gripper ring of the first connector portion has at least one first portion which has a maximum radial distance which is marginally greater than the inner diameter of the first pipe and at least one second portion having a radial distance less than the inner diameter of the first pipe; and
the second gripper ring of the second connector portion has at least one first portion which has a maximum radial distance which is marginally greater than the inner diameter of the second pipe and at least one second portion having a radial distance less than the inner diameter of the first pipe.

13. A fitting as defined in claim 12 wherein the at least one second portion of the first gripper ring of the first connector portion is a slot; and
the at least one second portion of the second gripper ring of the second connector portion is a slot.

14. A fitting as defined in claim 13 wherein there are two second portions of the first gripper ring of the first connector portion and those second portions are diametrically-opposed slots; and
there are two second portions of the second gripper ring of the second connector portion and those second portions are diametrically-opposed slots.

15. A fitting as defined in claim 1 wherein a first gasket is positioned between the two first concentric rings and a second gasket is positioned between the two second concentric rings.

16. A fitting as defined in claim 15 wherein the first gasket is seated to have a maximum outer radial distance no greater than the maximum outer radial distance of the first concentric rings; and
the second gasket is seated to have a maximum outer radial distance no greater than the maximum outer radial distance of the second concentric rings.

17. A fitting as defined in claim 1 wherein each of the first pipe, the second pipe, the first stopper ring and the second stopper ring has a colour, and wherein the colour of the first stopper ring is different than the colour of the first pipe and the colour of the second stopper ring is different than the second pipe.

18. A fitting as defined in claim 1 wherein the maximum outer peripheral radial distance of the first stopper ring from the longitudinal axis of the first connector portion is less than one half of the minimum outer diameter of the first crimp ring when crimped; and
the maximum outer peripheral radial distance of the second stopper ring from the longitudinal axis of the second connector portion is less than one half of the minimum outer diameter of the second crimp ring when crimped.

19. A fitting as defined in claim 1 wherein the fitting is made of plastic.

20. A fitting as defined in claim 1 wherein each of the first pipe and second pipe is PEX pipe or a composite pipe.

21. A method of connecting a first pipe having a pre-determined inner diameter to a second pipe having a pre-determined inner diameter, comprising
providing a fitting comprising:
a first connector portion for insertion into a first pipe having a pre-determined inner diameter and to be secured within the first pipe by a first crimp ring;
a second connector portion for insertion into a second pipe having a pre-determined inner diameter and to be secured within the second pipe by a second crimp ring;
the first connector portion having a first longitudinal, cylindrical portion for insertion into the first pipe, and wherein the first cylindrical portion has a lead end for insertion into the first pipe and a trailing end opposite to the lead end;
two first spaced-apart concentric rings on a radially-outer portion of the first cylindrical portion wherein a maximum outer radial distance of the first concentric rings is no greater than the inside diameter of the first pipe;
a first stopper ring positioned at the trailing end of the first cylindrical portion of the first connector portion and at a pre-determined longitudinal distance from the first concentric rings, and wherein the pre-determined longitudinal distance is determined such that when the first crimp ring is crimped in place the first concentric rings will be positioned in a functionally-acceptable position relative to the first crimp ring; and
the second connector portion having a second longitudinal, cylindrical portion for insertion into the second pipe, and wherein the second cylindrical portion has a lead end for insertion into the second pipe and a trailing end opposite to the lead end;
two second spaced-apart concentric rings on a radially-outer portion of the first cylindrical portion wherein a maximum outer radial distance of the second concentric rings is no greater than the inside diameter of the second pipe; and;
a second stopper ring positioned at the trailing end of the second cylindrical portion of the second connector portion and at a pre-determined longitudinal distance from the second concentric rings, and wherein the pre-determined longitudinal distance is determined such that when the second crimp ring is crimped in place the second concentric rings will be positioned in a functionally-acceptable position relative to the second crimp ring.
inserting the first cylindrical portion of the first connector portion of the fitting into the first pipe such that a forward end of the first pipe is adjacent to the first stopper ring;
inserting the second cylindrical portion of the second connector portion into the second pipe such that a forward end of the second pipe is adjacent to the second stopper ring;
positioning and crimping a first crimp ring around the first pipe adjacent to the first stopper ring of the first connector portion to secure the first pipe to the first connector portion of the fitting, and
positioning and crimping a second crimp ring around the second pipe adjacent to the second stopper ring of the second connector portion of the fitting to secure the second pipe to the second connector portion of the fitting.

22. A method as defined in claim 21 wherein the first crimp ring abuts against the first stopper ring of the first connector portion of the fitting, and the second crimp ring abuts against the second stopper ring of the second connector portion of the fitting.

23. A method as defined in claim 21 wherein the first crimp ring has an inner diameter;
the first stopper ring of the first connector portion has an outer periphery and at least one first portion of the outer periphery has a first predetermined radial distance from the longitudinal axis of the first connector portion which is greater than one half the inner diameter of the first crimp ring before it is crimped;
the second crimp ring has an inner diameter; and
the second stopper ring of the second connector portion has an outer periphery and at least one first portion of the outer periphery has a first predetermined radial distance from the longitudinal axis of the second connector portion which is greater than one-half the inner diameter of the second crimping ring before it is crimped

24. A method as defined in claim 23 wherein the first predetermined radial distance of the at least one first portion of the outer periphery of the first stopper ring of the first connector portion is a circular periphery having an outer diameter greater than the inner diameter of the first crimp ring; and
the second predetermined radial distance of the at least one first portion of the outer periphery of the second stopper ring of the second connector portion is a circular periphery having an outer diameter greater than the inner diameter of the second crimp ring.

25. A method as defined in claim 23 wherein the there is an upper limit of the maximum inner diameter of a properly-crimped first crimp ring;
the first stopper ring of the first connector portion has at least one second portion of its outer periphery at a second pre-determined radial distance that corresponds to the upper limit of the maximum inner diameter of a properly-crimped first crimp ring;
there is an upper limit of the maximum inner diameter of a properly-crimped second crimp ring; and
the second stopper ring of the second connector portion has at least one second portion of its outer periphery at a second pre-determined radial distance that corresponds to the upper limit of the maximum inner diameter of a properly-crimped second crimp ring.

26. A method as defined in claim 23 wherein the first stopper ring has at least one flat peripheral portion and each flat peripheral portion has a print that corresponds to the upper limit of the maximum inner diameter of a properly-crimped first crimp ring;
the second stopper ring has at least one flat peripheral portion and each flat peripheral portion has a point that corresponds to the upper limit of the maximum inner diameter of a properly-crimped second crimp ring;
there are two or more second portions of the second stopper ring of the second connector portion and each of those second portions is flat.

27. A method as defined in claim 26 wherein the first stopper ring of the first connector portion has at least one third portion of its outer periphery at a third pre-determined radial distance that is less than the outer diameter of a properly-crimped first crimp ring; and
the second stopper ring of the second connector portion has at least one third portion of its outer periphery at a third pre-determined radial distance that is less than the outer diameter of a properly-crimped second crimp ring.

28. A method as defined in claim 27 wherein the at least one third portion of the outer periphery of the first stopper ring on the first connector portion is a slot in the at least flat peripheral portion of the outer periphery of the first stopper ring of the first connector portion; and
the at least one third portion of the outer periphery of the second stopper ring on the second connector portion is a slot in the at least flat peripheral portion of the outer periphery of the second stopper ring of the second connector portion.

29. A method as defined in claim 28 wherein there are two slots in the at least one flat peripheral portion of the outer periphery of the first stopper ring of the first connector portion; and
there are two slots in the at least one flat peripheral portion of the outer periphery of the second stopper ring of the second connector portion.

30. A method as defined in claim 21 wherein the first cylindrical portion of the first connector has a first gripper ring on the radially-outer portion and at the lead end of the first connector portion; and
the second cylindrical portion of the second connector has a second gripper ring on the radially-outer portion and at the lead end of the second connector portion.

31. A method as defined in claim 30 wherein the first gripper ring of the first connector portion has a maximum radial distance which is marginally greater than the inner diameter of the first pipe; and
the second gripper ring of the second connector portion has a maximum radial distance which is marginally greater than the inner diameter of the second pipe.

32. A method as defined in claim 30 wherein the first gripper ring on the first connector portion has a first pipe-gripping edge facing towards the trailing end of the first cylindrical portion; and
the second gripper ring on the second connector portion has a second pipe-gripping edge facing towards the trailing end of the second cylindrical portion.

33. A method as defined in claim 30wherein the first gripper ring of the first connector portion has at least one first portion which has a maximum radial distance which is marginally greater than the inner diameter of the first pipe and at least one second portion having a radial distance less than the maximum radial distance of the at least one first portion of the first gripper ring of the first connector portion; and
the second gripper ring of the second connector portion has at least one first portion which has a maximum radial distance which is marginally greater than the inner diameter of the second pipe and at least one second portion having a maximum radial distance less than the radial distance of the at least one first portion of the second gripper ring of the second connector portion.

34. A method as defined in claim 33 wherein the at least one second portion of the first gripper ring of the first connector portion is a slot; and
the at least one second portion of the second gripper ring of the second connector portion is a slot.

35. A method as defined in claim 34 wherein there are two second portions of the first gripper ring of the first connector portion and those second portions are diametrically-opposed slots; and
there are two second portions of the second gripper ring of the second connector portion and those second portions are diametrically-opposed slots.

36. A method as defined in claim 21 wherein a first gasket is positioned between the two first concentric rings and a second gasket is positioned between the two second concentric rings.

37. A method as defined in claim 36 wherein the first gasket is seated to have a maximum outer radial distance no greater than the maximum outer radial distance of the first concentric rings; and
the second gasket is seated to have a maximum outer radial distance no greater than the maximum outer radial distance of the second concentric ring.

38. A method as defined in claim 21 wherein each of the first pipe, the second pipe, the first stopper ring and the second stopper ring has a colour, and wherein the colour of the first stopper ring is different than the colour of the first pipe and the colour of the second stopper ring is different than the second pipe.

39. A method as defined in claim 21 wherein the maximum outer peripheral radial distance of the first stopper ring from the longitudinal axis of the first connector portion is less than one half of the minimum outer diameter of the first crimp ring when crimped; and
the maximum outer peripheral radial distance of the second stopper ring from the longitudinal axis of the second connector portion is less than one half of the minimum outer diameter of the second crimp ring when crimped.

40. A method as defined in claim 21 wherein the fitting is made of plastic.

41. A method as defined in claim 21 wherein each of the first pipe and second pipe is PEX pipe or a composite pipe.

42. A pipe assembly comprising:
a first pipe having a pre-determined inner diameter,
a second pipe having a pre-determined inner diameter;
a fitting comprising a first connector portion and a second connector portion, wherein:
the first connector portion is inserted into the first pipe and secured within the first pipe by a first crimp ring;
the second connector portion is inserted into the second pipe and secured within the second pipe by a second crimp ring; and
wherein the fitting further comprises:
the first connector portion having a first longitudinal, cylindrical portion for insertion into the first pipe, and wherein the first cylindrical portion has a lead end for insertion into the first pipe and a trailing end opposite to the lead end;
two first spaced-apart concentric rings on a radially-outer portion of the first cylindrical portion wherein a maximum outer radial distance of the first concentric rings is no greater than the inside diameter of the first pipe;
a first stopper ring positioned at the trailing end of the first cylindrical portion of the first connector portion and at a pre-determined longitudinal distance from the first concentric rings, and wherein the pre-determined longitudinal distance is determined such that when the first crimp ring is crimped in place the first concentric rings will be positioned in a functionally-acceptable position relative to the first crimp ring; and
the second connector portion having a second longitudinal, cylindrical portion for insertion into the second pipe, and wherein the second cylindrical portion has a lead end for insertion into the second pipe and a trailing end opposite to the lead end;
two second spaced-apart concentric rings on a radially-outer portion of the first cylindrical portion wherein a maximum outer radial distance of the second concentric rings is no greater than the inside diameter of the second pipe; and;
a second stopper ring positioned at the trailing end of the second cylindrical portion of the second connector portion and at a pre-determined longitudinal distance from the second concentric rings, and wherein the pre-determined longitudinal distance is determined such that when the second crimp ring is crimped in place the second concentric rings will be positioned in a functionally-acceptable position relative to the second crimp ring.

43. A pipe assembly as defined in claim 42 having a fitting as defined in claim 1.
